(19) United States
(12) Patent Application Publication
(10) Pub. No.: US 2016/0128891 A1
(43) Pub. Date: May 12, 2016

(54) METHOD AND APPARATUS FOR PROVIDING SPACE INFORMATION

(71) Applicant: ELECTRONICS AND TELECOMMUNICATIONS RESEARCH INSTITUTE, Daejeon (KR)

(72) Inventors: Kyung-Hwan PARK, Daejeon (KR); Byoung-Gun CHOI, Daejeon (KR); Tae-Wook KANG, Daejeon (KR); Sung-Eun KIM, Daejeon (KR)

(21) Appl. No.: 14/933,398

(22) Filed: Nov. 5, 2015

(30) Foreign Application Priority Data
Nov. 10, 2014 (KR) 10-2014-0155492

(51) Int. Cl. A61H 3/06; H04S 7/00; G01S 15/93; G01S 7/526; G01S 7/539

(52) U.S. Cl. CPC A61H 3/061; G01S 7/526; G01S 7/539; G01S 15/93; H04S 7/303; H04S 2400/09; H04S 2400/15

(57) ABSTRACT

A method and an apparatus for providing space information to a visually handicapped person using a reflected sound of ultrasonic wave. The apparatus for providing space information includes: an ultrasonic transmitting and receiving unit transmitting an ultrasonic wave for acquiring the space information to a surrounding space and receiving a reflected sound of ultrasonic wave reflected from obstacles through at least two channels; and a stereophonic sound converting unit converting the received reflected sound into an audible sound and outputting the audible sound.

### CROSS REFERENCE TO RELATED APPLICATION

This application claims the benefit of Korean Patent Application No. 10-2014-0155492, filed on Nov. 10, 2014, entitled “Method and Apparatus for Providing Space Information”, which is hereby incorporated by reference in its entirety into this application.

### BACKGROUND OF THE INVENTION

1. Technical Field

The present invention relates to a method and an apparatus for providing space information, and more particularly, to a method and an apparatus for providing space information to a visually handicapped person using a reflected sound of ultrasonic wave.

2. Description of the Related Art

Visually handicapped persons may not use the sense of vision and therefore have considerable difficulty in recognizing obstacles, stairs, walls, gates, hallways, etc., in their daily lives. On the other hand, there has been known that a bat or a dolphin that does not use visual sensation detects obstacles or food using an ultrasonic wave. Based on the ideas, the organization “World Access for Blind” teaches how to perceive a space by adaptation training to a reflected sound. However, this is a program which is mainly led by so-called “batmen” having highly developed sense of hearing. The program has disadvantages in that the general visually handicapped person needs much time to learn space perception ability by the adaptation training and has inconvenience of continuously making a sound through his/her mouth and the sound may be noise offensive to other persons.

A background art of the present invention is disclosed in Korean Patent Laid-Open Publication No. 10-2013-0020361 (Feb. 27, 2013).

### SUMMARY OF THE INVENTION

The present invention has been made in an effort to provide a method and an apparatus for providing space information using a reflected sound of ultrasonic wave to solve problems of sound generation and noise by using the ultrasonic wave that other persons may not hear and perceive a space upon hearing a stereophonic sound by proposing a technology of converting the reflected sound of ultrasonic wave into the stereophonic sound.

According to an exemplary embodiment of the present invention, there is provided an apparatus for providing space information, including: an ultrasonic transmitting and receiving unit transmitting an ultrasonic wave for acquiring the space information to a surrounding space and receiving a reflected sound of ultrasonic wave reflected from obstacles through at least two channels; and a stereophonic sound converting unit converting the received reflected sound into an audible sound and outputting the audible sound.

According to another exemplary embodiment of the present invention, there is provided a method for providing space information, including: generating an ultrasonic pulse; converting the ultrasonic pulse into an ultrasonic wave and transmitting the ultrasonic wave to a surrounding space; receiving a reflected sound of ultrasonic wave through at least two channels; and converting the received reflected sound into an audible sound and outputting the audible sound.

### BRIEF DESCRIPTION OF THE DRAWINGS

FIG. 1 is a diagram illustrating an environment to which an apparatus for providing space information according to an exemplary embodiment of the present invention is applied.

FIG. 2 is a block diagram illustrating in more detail a configuration of the apparatus for providing space information according to the exemplary embodiment of the present invention.

FIG. 3 is a flow chart illustrating a method for providing space information according to an exemplary embodiment of the present invention.

### DESCRIPTION OF EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to the specific exemplary embodiments, but includes all modifications, equivalents, and substitutions included in the spirit and the scope of the present invention. Further, when it is determined that the detailed description of the known art related to the present invention may obscure the gist of the present invention, the detailed description thereof will be omitted. A singular form used in the present specification and the following claims is to be interpreted to generally mean “one or more” unless mentioned to the contrary.

Hereinafter, exemplary embodiments of the present invention will be described with reference to the accompanying drawings, and in describing the accompanying drawings, like components are denoted by like reference numerals and the overlapping description thereof will be omitted.

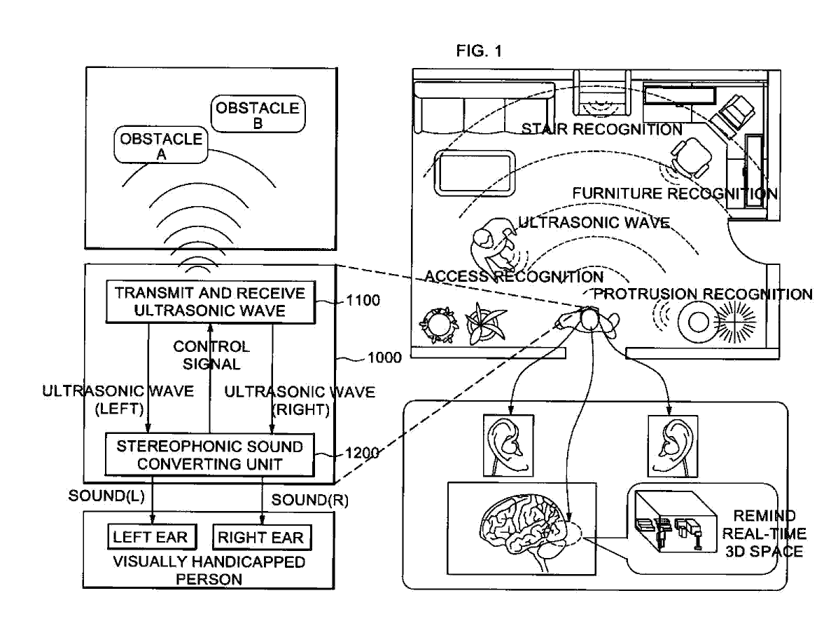

FIG. 1 is a diagram illustrating an environment to which an apparatus for providing space information according to an exemplary embodiment of the present invention is applied.

As illustrated in FIG. 1, an apparatus 1000 for providing space information according to an exemplary embodiment of the present invention is provided to a visually handicapped person in any space to enable the visually handicapped person to recognize facilities (for example, wall, stair, etc.), obstacles (for example, person, moving objects, etc.), etc., that exist in a surrounding space, through his sense of hearing.

The existing guide apparatus for the visually handicapped person uses voice/alarm/vibration, etc., but is configured to provide only distance information in one direction at a time and therefore has a limit of simultaneously receiving the space information in front and back/left and right/up and down directions. On the other hand, the apparatus 1000 for providing space information according to the exemplary embodiment of the present invention is an apparatus for maximally utilizing direction/distance/height recognition functions of a sound source that human ears have and may include a function of converting a reflected sound of ultrasonic wave into an audible sound that a person may hear and a function of preventing stereophonic sound characteristics included in the reflected sound from being lost.

In detail, the apparatus 1000 for providing space information includes an ultrasonic transmitting and receiving unit 1100 and a stereophonic sound converting unit 1200.

The ultrasonic transmitting and receiving unit 1100 converts an ultrasonic pulse (control signal) generated from the stereophonic sound converting unit 1200 into an ultrasonic wave to be transmitted to the surrounding space and receives the reflected sounds of the ultrasonic waves reflected from surrounding obstacles through at least two channels.

The stereophonic sound converting unit 1200 generates the ultrasonic pulse to be transmitted to the surrounding space to acquire the space information and transmits the generated ultrasonic pulse to the ultrasonic transmitting and receiving unit 1100 and converts the reflected sound received by the ultrasonic transmitting and receiving unit 1100 into the audible sound to be output.

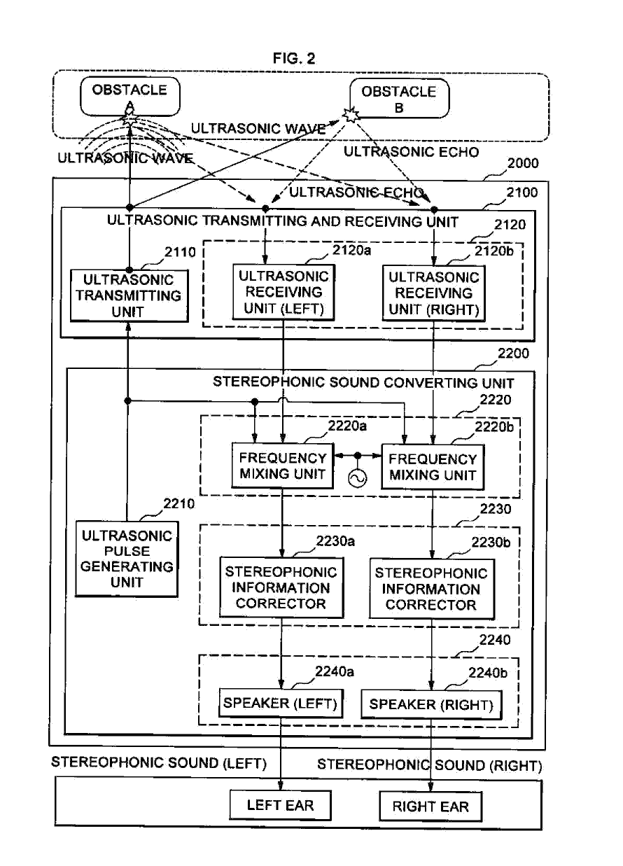

FIG. 2 is a block diagram illustrating in more detail a configuration of the apparatus for providing space information according to the exemplary embodiment of the present invention.

Referring to FIG. 2, the apparatus 2000 for providing space information includes an ultrasonic transmitting and receiving unit 2100 and a stereophonic sound converting unit 2200.

According to an exemplary embodiment, the ultrasonic transmitting and receiving unit 2100 may include an ultrasonic transmitting unit 2110 and an ultrasonic receiving unit 2120.

The ultrasonic transmitting unit 2110 converts the ultrasonic pulse generated from the stereophonic sound converting unit 2100 into the ultrasonic wave and transmits the ultrasonic wave to the surrounding space.

For example, the ultrasonic transmitting unit 2110 may use a piezoelectric effect to convert the ultrasonic pulse generated from the stereophonic sound converting unit 1100 into the ultrasonic wave. Here, the piezoelectric effect is a primary piezoelectric effect (positive piezoelectric effect) as a phenomenon that a mechanical distortion is applied to any material to generate dielectric polarization and is an inverse piezoelectric effect or a secondary piezoelectric effect as a phenomenon that an electric field is inversely applied to any material to cause a distortion. The generation of the ultrasonic wave uses the inverse piezoelectric effect. If an alternating current voltage is applied to a piezoelectric device, a deformation and an original form of the piezoelectric device are alternately generated, which becomes vibration energy to generate the ultrasonic wave. The alternating current voltage is the ultrasonic pulse generated from the stereophonic sound converter 1200 and the ultrasonic wave depending on the ultrasonic pulse is generated from the ultrasonic transmitting unit 2110 and transmitted to the surrounding space.

The ultrasonic receiving unit 2120 receives the reflected sounds of the ultrasonic waves reflected from obstacles of the surrounding space. For example, a method for receiving the reflected sound of ultrasonic wave may use the positive piezoelectric effect. When the ultrasonic receiving unit 2120 receives the received reflected sound of ultrasonic wave, a voltage generated by the positive piezoelectric effects is received as an electrical signal.

According to the exemplary embodiment, the ultrasonic receiving unit 2120 may include first and second receivers 2120a and 2120b to receive the reflected sound of ultrasonic wave through two channels, thereby preserving the space information included in the reflected sound of ultrasonic wave. In this case, the first and second receivers 2120a and 2120b are positioned corresponding to human ears and an interval between the receivers may be set to be equal or similar to an interval between both ears.

According to the exemplary embodiment, the stereophonic sound converting unit 2200 may include an ultrasonic pulse generating unit 2210, a frequency mixing unit 2220, a space information correcting unit 2230, and an audio output unit 2240.

The ultrasonic pulse generating unit 2200 generates the ultrasonic pulse generating the ultrasonic wave to be transmitted to the surrounding space to acquire the space information and transmits the generated ultrasonic pulse to the ultrasonic transmitting unit 2110. The ultrasonic pulse generating unit 2210 may adjust frequency characteristics, etc., of ultrasonic wave transmitted from the ultrasonic transmitting unit 2110 using the ultrasonic pulse.

Further, the ultrasonic pulse generating unit 2210 may transmit the ultrasonic pulse to the frequency mixing unit 2220 to determine a distance from obstacles using a time difference between the ultrasonic pulse and the reflected sound of ultrasonic wave.

The frequency mixing unit 2220 converts the reflected sound of ultrasonic wave received by the ultrasonic receiving unit 2120 into the audible sound.

According to the exemplary embodiment, the frequency mixing unit 2220 may include first and second frequency mixers 2220a and 2220b to convert each of ultrasonic signals received by each of the first and second ultrasonic receivers 2120a and 2020b into the audible sound signals.

For example, the first and second frequency mixers 2220a and 2220b convert the reflected sound signal of ultrasonic wave into an audible sound band signal based on the frequency mixing.

Further, the frequency mixing unit 2220 may also convert the ultrasonic pulse generated from the ultrasonic pulse generating unit 2210 into the audible sound band to be output to the user so that the user recognizes the time difference between ultrasonic transmitting timing and receiving timing of the reflected sound of ultrasonic wave using human ears to determine a relative distance from obstacles.

Alternatively, to prepare for the case in which the interval between the ultrasonic pulse and a sound wave signal at the receiving timing of the reflected sound is too short and thus may not be substantially differentiated by human ears, the sound wave signal at the transmitting timing of the ultrasonic wave may be heard or may not be heard optionally.

The space information correcting unit 2230 may correct for the space information distortion generated while the frequency mixing unit 2220 converts the ultrasonic signal into the audible sound signal.

According to the exemplary embodiment, the space information correcting unit 2230 may include first and second space information correctors 2230a and 2230b to correct the distortions of the audible sound signals converted by the first and second frequency mixers 2220a and 2220b, respectively. Meanwhile, the exemplary embodiment illustrated in FIG. 2 illustrates the structure in which the space information correctors 2230a and 2230b are connected to the frequency mixers 2220a and 2220b but in some exemplary embodiments, the space information correctors 2230a and 2230b may be directly connected to the ultrasonic receivers 2120a and 2120b to perform the distortion correction on the reflected sound signal of ultrasonic wave.

Further, although not illustrated in FIG. 2, the stereophonic sound converting unit 2200 may further include an amplifier for amplifying the reflected sound signals of ultrasonic wave received by the ultrasonic receivers 2120a and 2120b or the audible sound signals converted by the frequency mixers 2220a and 2220b.

The audio output unit 2240 outputs the ultrasonic pulse converted into the audible sound and the received reflected sound in a sound form.

According to the exemplary embodiment, the audio output unit 2240 may include a first output unit 2240a and a second output unit 2240b to output the reflected sound received to preserve the space information in a form of at least two channels.

The audio output unit 1230 may be implemented as audio devices such as a speaker and an earphone.

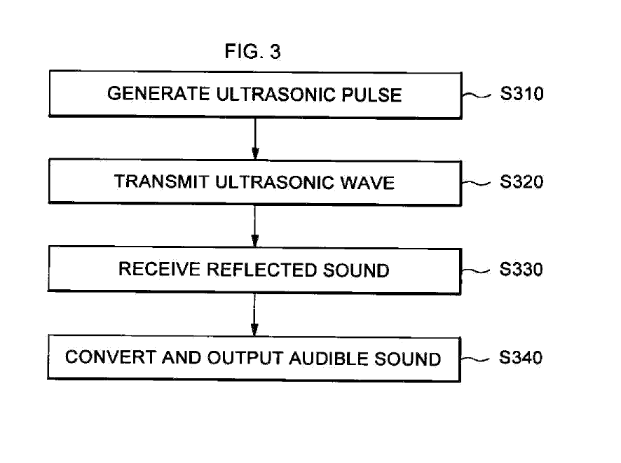

FIG. 3 illustrates a flow chart of a method for providing space information using a reflected sound of ultrasonic wave according to an exemplary embodiment of the present invention.

Referring to FIG. 3, the method for providing space information according to the exemplary embodiment of the present invention may include: generating an ultrasonic pulse (S310); converting the ultrasonic pulse into an ultrasonic wave and transmitting the ultrasonic wave to a surrounding space (S320); receiving the reflected sound of ultrasonic sound through at least two channels (S330), and converting the ultrasonic pulse and the received reflected sound into an audible sound and outputting the audible sound (S340).

In the step (S310), an electric pulse of an ultrasonic band for determining frequency characteristics, etc., of an ultrasonic wave to be transmitted to the surrounding space is generated to acquire the space information.

In the step (S320), the ultrasonic pulse is converted into the ultrasonic wave and transmitted to the surrounding space. For example, the ultrasonic pulse may be converted into the ultrasonic wave by the inverse piezoelectric effect.

In the step (S330), the reflected sound of ultrasonic wave reflected from the obstacle is received.

In the step (S340), the reflected sound is received through at least two channels to preserve the space information included in the reflected sound.

Here, when the reflected sound is received through the two channels, the receivers of each channel may be positioned at human ears and a distance between the receivers of each channel may be equal or similar to a distance between human ears. This is to more accurately provide the space information to human ears.

In the step (S340), the received reflected sound is converted into the audible sound band and is output.

Further, the user may recognize the time difference between the transmitting timing of the ultrasonic wave and the receiving timing of the reflected sound of ultrasonic wave using his/her ears by converting the ultrasonic pulse into the audible sound band to be output to determine the relative distance from the obstacles.

According to the exemplary embodiment, at least one signal of the reflected sound and/or the audible sound converted from the reflected sound may be amplified while the reflected sound is converted into the audible sound band.

Further, the distortion correction on at least one signal of the reflected sound and/or the audible sound converted from the reflected sound may be performed.

According to the exemplary embodiment, each of the audible sounds converted from the two channel reflected sounds is output to human ears through at least two speakers to enable the person to sense the space information.

The mechanism of differentiating the location of the sound source by human ears includes the complex factors such as the time difference between sounds reaching two ears, the phase change, the interference at a head and an auricle, the sound reflected from a shoulder, etc. The exemplary embodiments of the present invention may convert the spontaneous stereophonic sound factors included in the reflected sound of ultrasonic wave into the audible sound and provide the audible sound to both ears of the visually handicapped person, the low vision, the cybernaut, the three-dimensional game participant, etc., such that they may be reminiscent of the space structure in real time.

Hereinabove, the exemplary embodiment of the present invention will be described, but a person having ordinary skill in the art may variously, change, delete, add, etc., components without deviating from the ideas of the present invention described in claims and it is to be construed that these changed, deleted, and added components will be included in the scope of the present invention.

What is claimed is:

1. An apparatus for providing space information, comprising:
an ultrasonic transmitting and receiving unit transmitting an ultrasonic wave for acquiring the space information to a surrounding space and receiving a reflected sound of ultrasonic wave reflected from obstacles through at least two channels; and
a stereophonic sound converting unit converting the received reflected sound into an audible sound to be output.

2. The apparatus of claim 1, wherein the stereophonic sound converting unit converts the ultrasonic wave for acquiring the space information into the audible sound and outputs the converted ultrasonic wave.

3. The apparatus of claim 1, wherein the ultrasonic transmitting and receiving unit includes:
an ultrasonic transmitting unit converting an ultrasonic pulse generated from the stereophonic sound converting unit into the ultrasonic wave and transmitting the ultrasonic wave to the surrounding space; and
an ultrasonic receiving unit receiving the reflected sound of ultrasonic wave through the at least two channels.

4. The apparatus of claim 1, wherein the stereophonic sound converting unit includes:
an ultrasonic pulse generating unit generating the ultrasonic pulse; and
a frequency mixing unit converting the ultrasonic pulse and the received reflected sound into the audible sound.

5. The apparatus of claim 1 wherein the stereophonic sound converting unit further includes an amplifier for amplifying at least one of the received reflected sound and the reflected sound converted into the audible sound.

6. The apparatus of claim 1, wherein the stereophonic sound converting unit further includes a space information correcting unit for correcting a distortion of at least one of the received reflected sound and the reflected sound converted into the audible sound.

7. The apparatus of claim 1, wherein the stereophonic sound converting unit includes an audio output unit outputting the reflected sound converted into the audible sound through the at least two channels.

8. The apparatus of claim 3, wherein the ultrasonic receiving unit includes first and second receivers and the first and second receivers are each provided at positions corresponding to positions of human left and right ears.

9. A method for providing space information, comprising:
generating an ultrasonic pulse;
converting the ultrasonic pulse into an ultrasonic wave and transmitting the ultrasonic wave to a surrounding space;
receiving a reflected sound of ultrasonic wave through at least two channels; and
converting the received reflected sound into an audible sound to be output.

10. The method of claim 9, further comprising:
converting the ultrasonic pulse into the audible sound and outputting the audible sound.

11. The method of claim 9, further comprising:
amplifying at least one of the received reflected sound and the reflected sound converted into the audible sound.

12. The method of claim 9, further comprising:
correcting a distortion of at least one of the received reflected sound and the reflected sound converted into the audible sound.
